(19) United States
(12) Patent Application Publication
(10) Pub. No.: US 2009/0244697 A1
(43) Pub. Date: Oct. 1, 2009

(54) Optical recording and/or reproduction unit

(76) Inventor: Jürgen Tümpner, Münster (DE)

Correspondence Address: COLLARD & ROE, P.C., 1077 NORTHERN BOULEVARD, ROSLYN, NY, 11576, US

(21) Appl. No.: 11/990,788

(22) PCT Filed: Aug. 23, 2006
(86) PCT No.: PCT/EP2006/008264

§ 371 Date: Feb. 21, 2008

(30) Foreign Application Priority Data
Aug. 26, 2005 (DE) 10 2005 040 750.1

(51) Int. Cl. G02B 21/36; G05B 19/19

(52) U.S. Cl. 359/363; 318/568.1

(57) ABSTRACT

The invention relates to an optical recording and/or reading unit particularly suitable for scanning, preferably, a biological sample (1). Substantially, the unit comprises an optical unit (4) and/or a scanning unit (12) and also comprises a control arrangement (10) and at least one adjustment unit (6, 7, 8; 13, 14) loaded by an operator and comprising at least one adjusting element (7, 14). According to the invention, the movements of said adjusting element (7, 14) are evaluated by the control arrangement (10) and generate at least one feedback signal for the operator in the case when one or several values of a predefined threshold are attained or exceeded.

The invention relates to an optical recording and/or reproduction unit, particularly for scanning a preferably biological sample, having an optical unit and/or scanning unit, furthermore having a control system, and having at least one adjustment unit on which an operator can act, having at least one operating element.

Such an optical recording and/or reproduction unit is described, for example, in U.S. Pat. No. 4,760,385, and is furthermore known from practice. The optical unit can be one or more microscope lenses. The scanning unit is usually present in the form of a CCD chip and is situated in the image plane of the optical unit, in order to transmit images of the biological sample taken there to the control system, for further processing there.—Alternatively to this, only one optical unit can also be provided, if an operator observes the sample directly, for example through an eyepiece.

Motor control with a changeover to manual control is known from DE 38 24 547 A1. This is used in the case of an X/Y table with an injection device, for example. Position pulse transducers as well as handles for manual adjustment are situated on the motors for the X/Y table. The pulses of the position pulse transducers go to multiple counters in a control mechanism. In the control mechanism, the counter values are passed on to a microprocessor that operates the motors.—In accordance with predetermined criteria, the microprocessor can open a relay, so that at least one motor can be switched to be without current and adjustable by hand.

The state of the art is not satisfactory in all points. For example, there is the problem, in the case of so-called manual microscopy, that the images produced are generally observed by way of the eyepiece, and then are no longer available for subsequent more in-depth evaluation. It is true that there are already approaches, in the aforementioned U.S. Pat. No. 4,760,385, in the direction of assuring simultaneous image recording and evaluation. Then, however, the work proceeds mainly automatically. This means that here, manual image or frame selection is not possible, for example. This is where the invention takes its start.

The invention is based on the technical problem of further developing an optical recording and/or reproduction unit of the type described initially, in such a manner that manual operation can be combined with the advantages of automatic scanning and subsequent image evaluation.

In order to solve this technical problem, an optical recording and/or reproduction unit of the type stated is characterized, within the framework of the invention, in that movements of the operating element are evaluated by the control system, and, if one or more predetermined threshold values are reached and/or exceeded, they produce at least one feedback signal for the operator.

By means of these measures, according to the invention, first of all, unchanged manual and therefore conventional operation of the optical recording and/or reproduction unit is ensured. This is because the related operating element is manually acted on by the operator. This can be done in such a manner that the operator manually acts directly on the operating element, in each instance, for example one or more rollers for adjusting a sample table, so that regions of the sample that are of interest, in each instance, get into the viewing field. Of course, it also lies within the scope of the invention to put a servo motor in between, and to detect the manual movement of the operating element with sensors and convert it into related setting movements for the servo motor. In addition, adjustment unit, of course, does not mean only a unit for adjusting the sample table—in most cases in the X and Y direction. Instead, this can also be understood to be a setting drive in the Z direction, alternatively or supplementally, which is used to have the optical unit, i.e. a lens that is generally implemented there, undergo a height adjustment and consequently a focus adjustment relative to the sample table. Furthermore, alternatively or supplementally, an adjustment unit is also possible that is used to adjust a filter, for example a gray-stage filter, to influence the image.

To state it differently, the adjustment unit comprises all of the setting elements of the optical recording and/or reproduction unit that influence recording and/or reproduction of the image in any manner whatsoever. These setting elements are, i.e. the adjustment unit in general is operated manually, in conventional manner, in order to allow the observer or operator, in each instance, to select the images in targeted manner, and to emphasize particularly interesting regions of the sample to be examined. So that this process can not only be observed directly in the eyepiece and/or on the reproduction unit, but also subsequent electronic evaluation of recorded images, in the sense of image processing, is made possible, the operator receives the one or more feedback signals already mentioned. In this connection, the feedback signal, in each instance, is generated as a function of the movement of the operating element of the adjustment unit.

In fact, the control system evaluates the relevant movements of the operating element, and compares these actual movements with predetermined reference values or threshold values. As soon as such a predetermined reference value or threshold value is reached or exceeded, the control system outputs the related feedback signal for the operator. It is advantageous if this feedback signal is a tactile and/or acoustical and/or optical operator stimulus.

This means that according to the invention, the senses of touch and/or hearing and/or sight are addressed. Fundamentally, the control system can also act on the sense of taste and/or smell. However, since the related sensory organs are relatively imprecise and do not work reproducibly, and stimulating them is problematical, the work is carried out with the tactile and/or acoustical and/or optical operator stimuli, in most cases. In this connection, the tactile operator stimuli are particularly important, because a user generally looks at the sample through the eyepiece and/or on the reproduction unit, so that an additional optical stimulus might pass unnoticed. An acoustical stimulus is generally connected with the disadvantage that it might bother other people, and also the operator might not notice it. In contrast, tactile operator stimuli are connected with the advantage that they act directly on the sense of touch, consequently they meet with particular attention from the operator, who is acting on the operating element, in each instance, with his hands and by way of the sense of touch.

In order to now produce these operator stimuli in detail, a manipulation unit is preferably assigned to the operating element. Using this manipulation unit, the movement of the operating element and/or its movement speed can be changed when the threshold value is reached and/or exceeded. It is possible here that in the simplest case, the manipulation unit brakes the movement of the operating element and/or sets it to coast. In the first case mentioned, the manipulation unit is configured as a braking unit, while the variant last mentioned corresponds to a coasting unit. Alternatively or in addition, a vibration unit can also be provided as a manipulation unit. This causes the operating element—in most cases, this involves the one or more rollers already mentioned—to vibrate. In every case, the operator's sense of touch is directly addressed, and the operator is provided with feedback concerning the fact that a previously set threshold value has been reached and/or exceeded.

In order to now preset this threshold value or reference value in the control system, the control system can be equipped with an input unit. Then the threshold value can be set by the operator. Alternatively to this, or in addition, it is also possible that the threshold value, in each instance, is automatically preset, depending on the process for image recording and/or image reproduction initiated by the control system. In this connection, different threshold values can be set and preset, if necessary. These threshold values are suitable for simulating and/or replacing end switches that would also be possible at this point, for example. In both cases, the optical unit or a lens, for example, is prevented from damaging the sample, or vice versa. This means that the possibility of the sample damaging the lens is also excluded by this.

It has proven itself, in this connection and also otherwise, if the operating element is mechanically uncoupled from the adjustment unit. This is because in this way, the operating element can be equipped with the coasting unit mentioned, in simple manner, i.e. the desired coasting can be achieved without problems. Furthermore, this method of procedure makes it possible that the operating element does not act mechanically on the adjustment unit directly, but rather by way of an interposed servo motor.

In order to now register the movements of the operating element—independent of whether or not the operating element is now mechanically coupled with the adjustment unit—at least one sensor is generally provided on the operating element. The sensor detects the movements of the operating element and transmits these to the control system for evaluation. The sensor can be, without restriction, an encoder, in other words a system consisting of hardware and software that encodes the movements generated by the operating element, if necessary, and passes them on to the control system, compressed as digital data. One way or the other, the control system is comprehensively informed about movements of the operating element, and also about its current position, by means of the at least one sensor. This means that a conclusion can be drawn from the position of the operating element, concerning that of the sample table, for example, and consequently concerning the position of the sample in relation to the optical unit and/or scanning unit, which are generally fixed in the X and Y direction.

Furthermore, the threshold values can be stored in the memory of the control system and queried as needed, in each instance. At the same time, there is the possibility of converting the threshold values into operator stimuli, in each instance, as soon as the operating element has reached and/or exceeds the threshold value, in each instance. In this manner, the operating element is equipped with a kind of tactile rastering that informs the operator about the threshold values, in each instance.

This is required, for example, when moving the sample table in the X/Y direction, in order to be able to record the individual selected image segments or frames in the scanning unit with overlap. This overlap between the individual frame or image segments is required in order to be able to set the individual frames against one another in as error-free a manner as possible in a subsequent step, to produce an overall image. Furthermore, this process makes it possible for the individual frames to be recorded at all, because recording requires the sample table to come to a stop for a certain period of time. For this purpose, the operating element can be braked by the control system, in each instance, or switched to the “coasting” position, in order to allow the recording process.

Completely aside from this, the invention guarantees, in the case of the Z setting operation for the optical unit that was already mentioned initially, that—for example in the case of a sample having a three-dimensional structure—sharp images are recorded in the individual image segments. In this connection, the manipulation unit can mark the borders of the depth focus region, in each instance, as the operator stimulus, in each instance. Finally, in this connection, images in which the focal plane defined by the optical unit is displaced by equidistant distances, in each instance, are also successful. The distance, in each instance, again corresponds to a corresponding operator stimulus. Of course, changing, non-equidistant distances can also be implemented in this connection.

In every case, the invention makes it possible, for the first time, for manual microscope operation to be combined with the simultaneous recording of individual sample images and their subsequent electronic image processing. This means that manual operation is synchronized with the requirements for electronic image recording, including subsequent image analysis processes. These are the significant advantages.

In the following, the invention will be explained in greater detail using a drawing that shows an embodiment merely as an example; this shows:

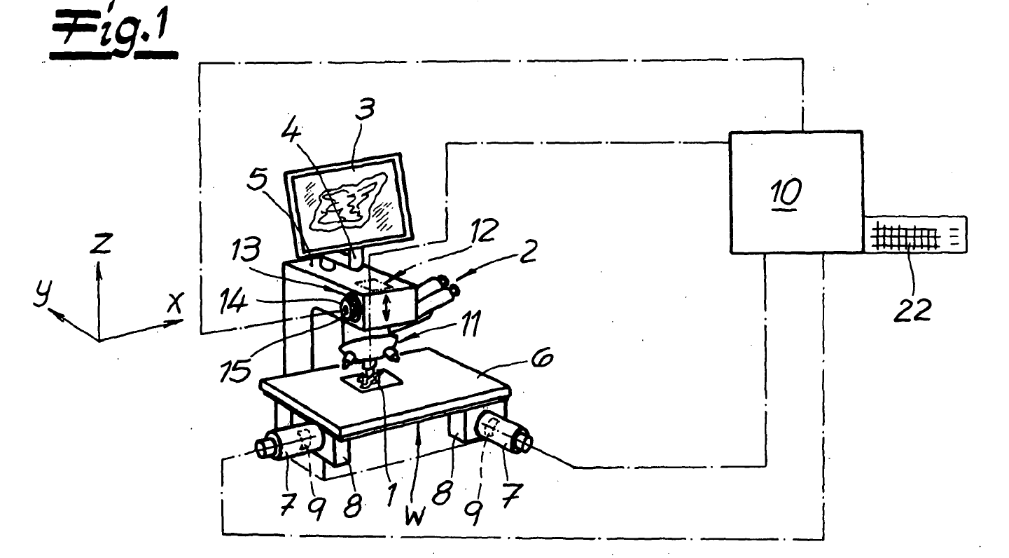

FIG. 1 an optical recording and/or reproduction unit according to the invention, in a schematic overview,

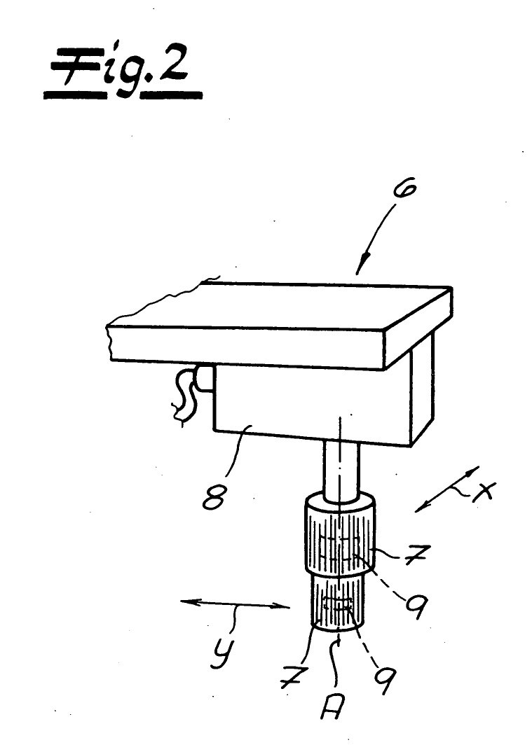

FIG. 2 details of the unit according to FIG. 1, and

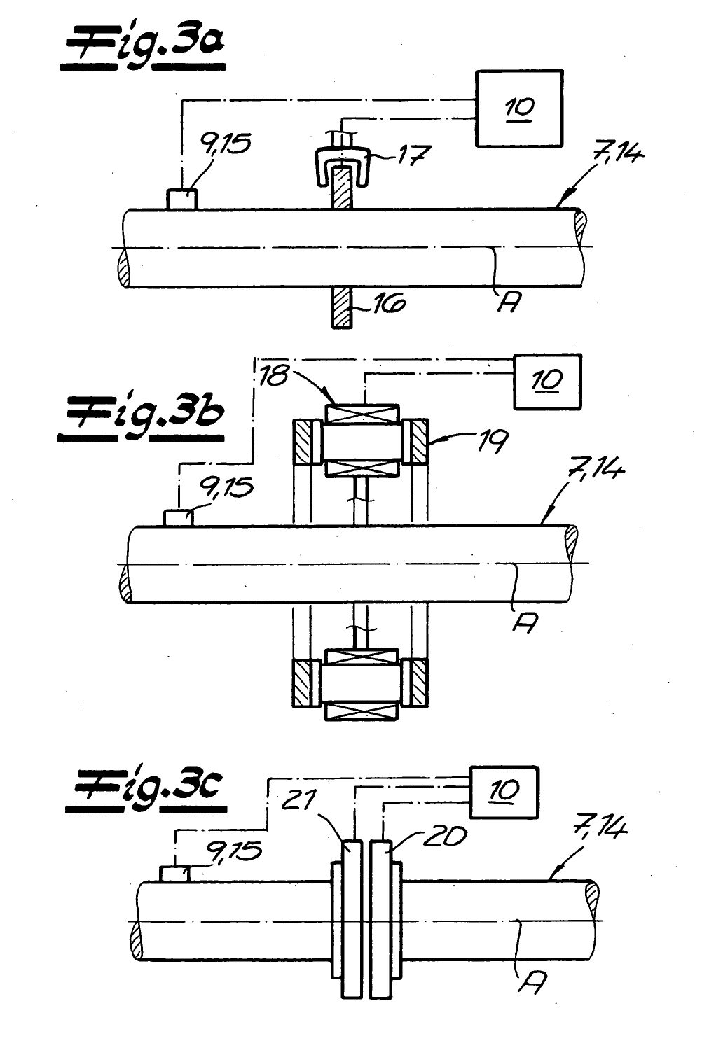

FIG. 3a to 3c various manipulation units for the operating element.

In the figures, an optical recording and/or reproduction unit is shown. In this connection, the exemplary embodiment relates, without restriction, to a microscope that allows observation of a sample 1 both through an eyepiece 2 and using a reproduction unit 3. Within the framework of the exemplary embodiment, this reproduction unit 3 is, without restriction, a (computer) screen, particularly a flat screen, which is connected to a base frame 5 using an adjustment arm or comparable device 4.

The base frame 5 accommodates a sample table 6, in supplementary manner, which table can be manually displaced by way of an operating element 7, i.e. by way of rollers 7, in the X/Y direction. The rollers 7 act directly on the sample table 6. Consequently, according to the embodiment primarily being pursued, no additional servo motors are necessary, but rather the sample table 6 is moved by muscle power alone. Depending on when specific threshold values that will be explained in greater detail below are reached, the operating element 7 is, i.e. the rollers 7 are uncoupled from the sample table 6 and/or braked. As a result, an operator receives direct feedback that the threshold value in question has been reached. This consequently already applies if a continuous mechanical connection from the roller 7, in each instance, to the sample table 6 is implemented.

Alternatively to this, however, the rollers 7 can also act on the sample table 6 by way of interposed and merely indicated servo motors 8.—In both cases, a sensor 9 is assigned to the roller 7 or to the operating element 7, in order to detect the movement of the roller 7 on the sample table 6. Using the sensor 9, the manually produced rotational movements of the roller 7 are converted into digital data that can be evaluated by a control system 10.

In fact, the sensor 9 is, without restriction, an encoder, or the sensor 9 is equipped with such an encoder, which prepares the sensor data for the connected control system 10.

In this manner, mechanical movements of the rollers 7 are detected by the sensor 9. If the optional servo motors 8 are implemented, these movements are converted into setting movements of the servo motors 8 for the sample table 6, by way of the control system 10. Otherwise, the sensor 9, in each instance, serves for determining that threshold values predetermined on the part of the control system 10, which values will be described in greater detail below, are reached, i.e. adhered to, in the case of a continuous mechanical connection from the roller 7 to the sample table 6.

Fundamentally, it is also possible, of course, to move the sample table 6 purely automatically, using the servo motors 8, by way of the control system 10, without the rollers 7 being acted on manually. Usually, however, the operator requests expressed by means of rotation of the rollers 7 are registered by the control system 10, i.e. are compared with predetermined threshold values, and converted into setting movements for the servo motors 8, if necessary.

In addition to this adjustment unit 6, 7, 8 composed of the rollers 7, the optional servo motors 8, and the sample table 6 driven by them, having the operating element 7, in each instance, the optical recording and/or reproduction device has an optical unit 11 and a scanning unit 12, in supplementary manner. Within the scope of the representation, the optical unit 11 is a lens turret having multiple microscope lenses. The optical unit 11 is connected with the control system 10, so that the desired microscope lens of the lens turret can be selected using the system. Furthermore, the entire optical unit 11 can be moved in the Z direction in this way, using an additional setting drive 13, in order to have a sharp image of the sample 1, in each instance, in the eyepiece 2 and/or on the reproduction unit 3.

Like the first adjustment unit 6, 7, 8, the setting drive 13 also has an operating element 14 that can be acted on manually, and forms the adjustment unit 13, 14 together with this element. The second adjustment unit 13, 14 is also connected with the control system 10. This is because another sensor 15 evaluates the movements of the operating element 14 and transmits them to the control system 10, which in turn acts on the setting drive 13 as a function of this. This means that the operating element 14 again is mechanically uncoupled from the adjustment unit 13.

In FIG. 2, it can be seen that within the framework of an alternative embodiment, the two rollers 7 for the X and Y adjustment can also be disposed collinear with one another. In this connection, the uppermost roller 7, having the greater diameter, without restriction, ensures an adjustment of the sample table 6 in the X direction, while the roller 7 disposed underneath it, having the smaller diameter, guarantees an adjustment in the Y direction. In both cases, the required sensor 9 on the roller 7, in each instance, makes it possible that not only are its movements detected by the control system 10, but also the position of the roller 7 and consequently of the sample table 6, in total, in the X and Y direction, are also detected. For this purpose, the sensor 9, in each instance, can pass counting pulses to the control system 10, which determines the position of the roller 7 and consequently that of the sample table 6 from this.

According to the invention, the movements of the operating element 7 or 14 are now evaluated by the control system 10, and if one or more predetermined threshold values or reference values are reached and/or exceeded, evaluated by the control system 10 to the effect that at least one feedback signal for the operator, in each instance, is generated. The possible feedback signals for the operator are tactile and/or acoustical and/or optical operator stimuli.

Within the scope of the exemplary embodiment, the operator only receives tactile operator stimuli, in other words those that address his sense of touch. For this purpose, the operating element 7, 14, in each instance, has a manipulation unit 16, 17; 18, 19; 20, 21 assigned to it, as shown in FIG. 3a to 3c, which changes the movements of the operating element 7, 14 and/or its movement speed when the threshold value or reference value in question is reached and/or exceeded. In this connection, the threshold values, in each instance, can be stored in the memory of the control system 10, and can be queried, in each instance, if needed. Operator stimuli can be generated using the threshold values, as soon as the operating element 7, 14 has reached and/or exceeds the threshold value, in each instance. This process corresponds to a tactile rastering of the operating element 7, 14, in each instance.

Within the framework of the exemplary embodiment according to FIG. 3a, a braking unit 16, 17 is implemented as the manipulation unit 16, 17. The latter is composed of a disk 16 that rotates with the operating element 7, 14, i.e. the corresponding roller, about its axis A, and a brake element 17 that brakes the disk 16 as necessary. The brake element 17 is acted on by the control system 10. This can involve a piezo element that expands in the direction toward the disk 16—acted on by the control system 10—and brakes it more or less—depending on the voltage applied. This braking to a stop, if necessary, is perceived by the operator as a tactile operator stimulus as the roller 7 rotates about the axis A.

In this manner, the sample table 6 can be stopped at a certain position in the X and/or Y direction, for example, so that sufficient time is available to image the sample 1, transilluminated by white-light source W, on the scanning unit 12 by the optical unit 4, and to generate a blur-free electronic image here, and subsequently pass it on to the control system 10 for image analysis. In this connection, the reading and transmission process can also take place only after the braking unit 16, 17 has already released the operating element 7, 14, in each instance, once again.

FIG. 3b shows a different braking unit 18, 19 in the form of an eddy-current brake for the operating element 7, 14. This functions, on the whole, in that a stator having a coil crown 18 is provided in a ring-shaped arrangement around the axis A. The roller, i.e. the operating element 7, 14 is not mechanically connected with the rotor 19 made of ferromagnetic material. The rotor 19 has two ring-shaped disks that frame the stator 18, i.e. its ring-shaped coils 18, and are separated from the latter by means of a narrow air gap. If the stator, i.e. the coils 18 now have a current applied to them by the control system 10, eddy currents are induced in the rotor 19, which brake the operating element 7, 14 that rotates about the axis A.

The variant according to FIG. 3c, finally, shows a clutch in the case of a separate shaft of the operating element 7, 14, of two clutch disks 20, 21 spaced apart from one another at an adjustable distance. Their distance can be varied using the control system 10, so that in this case, as well, all the possibilities for braking the operating element 7, 14 can be implemented, specifically from unbraked movement all the way to complete stopping of the operating element 7, 14. Furthermore, the variant according to FIG. 3c also allows implementing so-called coasting, which can also be produced, in the case of the exemplary embodiments according to FIG. 3a and 3b, in supplementary manner, in that the signals of the sensors 9, 15, in each instance, are converted into setting signals for the related setting drives, i.e. servo motors 8, 14 by the control system 10. In any case, this coasting corresponds to the situation that the roller 7, 14, in each instance, i.e. the operating element is acted on by the operator, without the related adjustment unit 6, 7, 8 or 13, 14 moving the sample table 6 and/or the optical unit 11.

Supplemental to this, coasting can be used to uncouple the sample table 6 and/or the optical unit 11 from the related operating element 7, 12 when an image is being recorded, in order to keep vibrations introduced into the base frame 5 out, for example, and to allow a sharp and blur-free image. The same is possible if so-called shading images are supposed to be recorded to correct images taken of the sample 1, in other words images that allow shading correction. This is understood to mean a correction of the illumination conditions that might have been set in non-homogeneous manner on the part of the white-light source W. This means that coasting is always used when the sample table 6 and/or the optical unit 11 are not allowed to be moved, whereby the control system 10 has corresponding data and spaces the two clutch disks 20, 21 apart from one another in the case of FIG. 3c as an example.

The control system 10 supplementally has an input unit 22 with which the threshold values can be preset from the outside; it is pointed out to the operator by the manipulation unit 16, 17; 18, 19; 20, 21, using the operator stimuli, that the threshold values in question have been reached and/or exceeded.—Not shown is the possibility of supplementally or alternatively coupling the operating element 7, 14 with a vibration unit, in order to thereby convert the situation of reaching and/or exceeding the threshold values into a related operator stimulus. Also not shown is an acoustical output unit that is connected to the operating elements 7, 14 and also indicates that the threshold values have been reached and/or exceeded—now by means of an acoustical operator stimulus, i.e. an alarm signal.

In any case, it is made possible that the optical recording and/or reproduction unit shown can be operated purely manually, whereby this manual operation simultaneously allows electronic optical scanning of the sample 1 by means of recording different image segments. This is because reaching the border of the image section, in each instance, is flanked by a related operator stimulus. At the same time, there is the possibility of temporarily uncoupling the operating element 7, 14 from the related adjustment unit 6, 7, 8 or 13, 14 for the sample table 6 and/or the optical unit 11.

This is because the operator stimulus mostly corresponds to the fact that the operating element 7, 14 is running in idle, specifically for a period of time required to electrically record the related image segment, using the scanning unit 12. A similar method of procedure is followed in the Z direction. Here, the operating element 14 is then switched to coasting or idle whenever the optical unit 11 is situated in the selected image segment, i.e. frame, in the region of the focal plane, i.e. within the permissible depth focus region. In this way, the invention, on the whole, allows depth focus images and comprehensive data about the height expanse of the sample 1, because a sharp image is guaranteed in every image segment or frame.

1: Optical recording and/or reproduction unit, particularly for scanning a preferably biological sample (1), having an optical unit (11) and/or a scanning unit (12), furthermore having a control system (10) and at least one adjustment unit (6, 7, 8; 13, 14) on which an operator can act, having at least one operating element (7, 14), wherein
the operating element (7, 14) is mechanically uncoupled from the adjustment unit (6, 7, 8; 13, 14), whereby
movements of the operating element (7, 14) are evaluated by the control system (10), and, if one or more predetermined threshold values are reached and/or exceeded, they produce at least one feedback signal for the operator.

2: Optical recording and/or reproduction unit according to claim 1, wherein the feedback signals for the operator are tactile and/or acoustical and/or optical operator stimuli.

3: Optical recording and/or reproduction unit according to claim 1, wherein a manipulation unit (16, 17; 18, 19; 20, 21) is assigned to the operating element (7, 14), which changes its movements and/or its movement speed when the threshold value is reached and/or exceeded.

4: Optical recording and/or reproduction unit according to claim 1, wherein the manipulation unit (16, 17; 18, 19; 20, 21) is equipped as a braking unit (16, 17; 18, 19) and/or coasting unit (20, 21).

5: Optical recording and/or reproduction unit according to claim 1, wherein the operating element (7, 14) has a vibration unit.

6. (canceled)

7: Optical recording and/or reproduction unit according to claim 1, wherein the operating element (7, 14) has at least one sensor (9, 15) that detects its movements and transmits them to the control system (10) for evaluation.

8: Optical recording and/or reproduction unit according to claim 1, wherein the control system (10) has an input unit 22 in order to preset at least one threshold value on the operator side.

9: Optical recording and/or reproduction unit according to claim 1, wherein the threshold values are stored in the memory of the control system (10), and queried as needed, in each instance, and converted into operator stimuli as soon as the operating element (7, 14) reaches and/or exceeds the threshold value, in each instance.

10: Optical recording and/or reproduction unit according to claim 1, wherein different threshold values are automatically preset, depending on the process initiated by the control system (10) for recording images and/or reproducing images.
